(19) United States
(12) Patent Application Publication
(10) Pub. No.: US 2023/0267373 A1
(43) Pub. Date: Aug. 24, 2023

(54) END-TO-END ARTIFICIAL INTELLIGENCE SYSTEM WITH UNIVERSAL TRAINING AND DEPLOYMENT

(71) Applicant: SliceX AI, Inc., Menlo Park, CA (US)

(72) Inventor: Sujith Ravi, Menlo Park, CA (US)

(21) Appl. No.: 18/112,982

(22) Filed: Feb. 22, 2023

Related U.S. Application Data
(60) Provisional application No. 63/313,657, filed on Feb. 24, 2022.
(60) Provisional application No. 63/313,658, filed on Feb. 24, 2022.

(51) Int. Cl. G06N 20/00

(52) U.S. Cl. CPC G06N 20/00

(57) ABSTRACT

A method and system for deploying a machine learning model include receiving a user request for deploying a machine learning model, for an application, to an edge device, determining a device constraint type associated with the edge device, where the device constraint type is one of a number of device constraint types associated with a plurality of edge devices capable of running the application, identifying a machine learning model corresponding to the device constraint type of the edge device, where the machine learning model is one of a number of tiers of machine learning models developed for the application according to the number of device constraint types, and deploying the machine learning model to the edge device.

### CROSS REFERENCE TO RELATED APPLICATION

This application claims the benefit of and priority to U.S. Provisional Patent Application No. 63/313,657 filed Feb. 24, 2022, and entitled “HYPER-EFFICIENT, PRIVACY-PRESERVING ARTIFICIAL INTELLIGENCE SYSTEM,” and U.S. Provisional Patent Application No. 63/313,658 filed Feb. 24, 2022, and entitled “END-TO-END ARTIFICIAL INTELLIGENCE SYSTEM WITH UNIVERSAL TRAINING AND DEPLOYMENT,” the entire disclosure of each of which is hereby incorporated by reference in its entirety for all purposes. This application is also related to U.S. patent application Ser. No. 18/112,917, filed on Feb. 22, 2023, and entitled “HYPER-EFFICIENT, PRIVACY-PRESERVING ARTIFICIAL INTELLIGENCE SYSTEM,” the entirety disclosure of which is hereby incorporated by reference in its entirety for all purposes.

### TECHNICAL FIELD

This disclosure generally relates to the field of artificial intelligence technology, and more particularly to end-to-end artificial intelligence systems with universal training and deployment and methods for using the same.

### BACKGROUND

Artificial intelligence is one of the key technologies that transform the world nowadays. It is a wide-ranging tool that enables people to ingest information, analyze data, and use the obtained insights to improve decision-making. In traditional machine learning, large servers are often used to process heaps of data collected from the Internet to provide insightful information, but they have limitations, e.g., unsafe and requiring at least some internet connection. By running machine learning algorithms on edge devices like laptops and mobile devices, it is expected that predictions become faster and safer without the requirement to transmit large amounts of raw data across a network.

However, deploying machine learning models to edge devices faces many challenges due to a large variety of edge devices. For example, edge devices not only include computer desktops and laptops, but also include wearable devices, IoT sensors, high-end surgical systems, mobile robots, smartphones, security cameras, internet-connected microwave ovens, and even some edge gateways and edge servers. Most currently available machine learning models only perform well in a small percentage of edge devices, which then limits the applications of machine learning models in a wide range of edge devices.

### SUMMARY

To address the aforementioned shortcomings, a method and system for universal training and deployment of machine learning models are provided. The method includes receiving a user request for deploying a machine learning model, for an application, to an edge device, determining a device constraint type associated with the edge device, where the device constraint type is one of a number of device constraint types associated with a plurality of edge devices capable of running the application, identifying a machine learning model corresponding to the device constraint type of the edge device, where the machine learning model is one of a number of tiers of machine learning models developed for the application according to the number of device constraint types, and deploying the machine learning model to the edge device.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 is a block diagram of an example model management system, according to embodiments of the disclosure.

FIG. 2 is a block diagram of example components included in a model management application, according to embodiments of the disclosure.

FIGS. 3A-3B illustrate example application scenarios for deploying a machine learning model to a variety of edge devices, according to embodiments of the disclosure.

FIG. 4 illustrates an example application scenario for deploying different tiers of machine learning models to edge devices with different constraints, according to embodiments of the disclosure.

FIG. 5 illustrates example pipeline components for training and inference on cloud and edge devices, according to embodiments of the disclosure.

FIGS. 6A-6D illustrate various example application scenarios for training and deploying models on cloud and edge devices, according to embodiments of the disclosure.

FIG. 7 illustrates an example application scenario where a model is personalized through a training process, according to embodiments of the disclosure.

FIGS. 8A-8D illustrate example processes for training a personalized model, according to embodiments of the disclosure.

FIG. 9 is a block diagram of an example computer for a model management system, according to embodiments of the disclosure.

### DETAILED DESCRIPTION

The Figures (FIGS.) and the following description relate to some embodiments by way of illustration only. It should be noted that from the following description, alternative embodiments of the structures and methods disclosed herein will be readily recognized as viable alternatives that may be employed without departing from the principles of the disclosure.

Reference will now be made in detail to several embodiments, examples of which are illustrated in the accompanying figures. It is to be noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

As described earlier, deploying machine learning models to edge devices face technical problems due to the different device constraints, which may limit a deployed machine learning model to operate properly only in a small percentage of edge devices. The technical solutions disclosed herein address these technical problems by providing end-to-end artificial intelligence systems with universal training and deployment.

According to one embodiment, the disclosed end-to-end artificial intelligence (AI) systems allow to develop a set of machine learning models with different sizes or complexities (e.g., different layers in a neuron network) where each machine learning model in the set is only deployed to a small percentage of edge devices. Accordingly, by developing a series of machine learning models for an application, each targeting a corresponding portion of edge devices with different constraints, the whole set of developed models may cover all edge devices with different constraints for the same application. Later, when an edge device is requesting a machine learning model, the device information including the device constraints may be determined. Based on the device constraints, a corresponding machine learning model may be selected, instantiated if not already existing, which ensures that the model operate properly when being deployed to the requesting device since the selected model is specifically developed (e.g., optimized) for the device or a family of devices with the similar device constraints.

In some embodiments, the disclosed AI systems may be not only device-specific (e.g., edge devices with similar constraints may have a corresponding model), but can be also user-specific. For example, user information (e.g., user data) may be included in the model training process, so that model parameters or weights can be tuned or optimized based on the user information. The as-trained model (which can be considered as “personalized model”), when deployed for the application, may generate an output that reflects one or more of user interests, user preferences, or other customized features when compared to un-personalized models.

The technical solutions disclosed herein show advantages over other existing machine learning systems. For example, since each machine learning model disclosed herein is developed and optimized based on the device constraints, each machine learning model may perform better in a specific edge device when compared to a machine learning model that is developed for various edge devices with a wide range of constraints. In addition, by personalizing a model, more user-customized information may be displayed to a user by the model, which then does not require a user to go through additional searches (e.g., more flips on a wearable device) to find expected information. This saves the energy source, the network bandwidth, and/or the computation resource of an edge device, which significantly affects the operation of edge devices, especially the ones with limited computation resources/energy source/bandwidth, such as wearable devices, VR/AR, embedded systems, and so on.

It is to be noted that the benefits and advantages described herein are not all-inclusive, and many additional features and advantages will be apparent to one of ordinary skill in the art in view of the figures and the following descriptions.

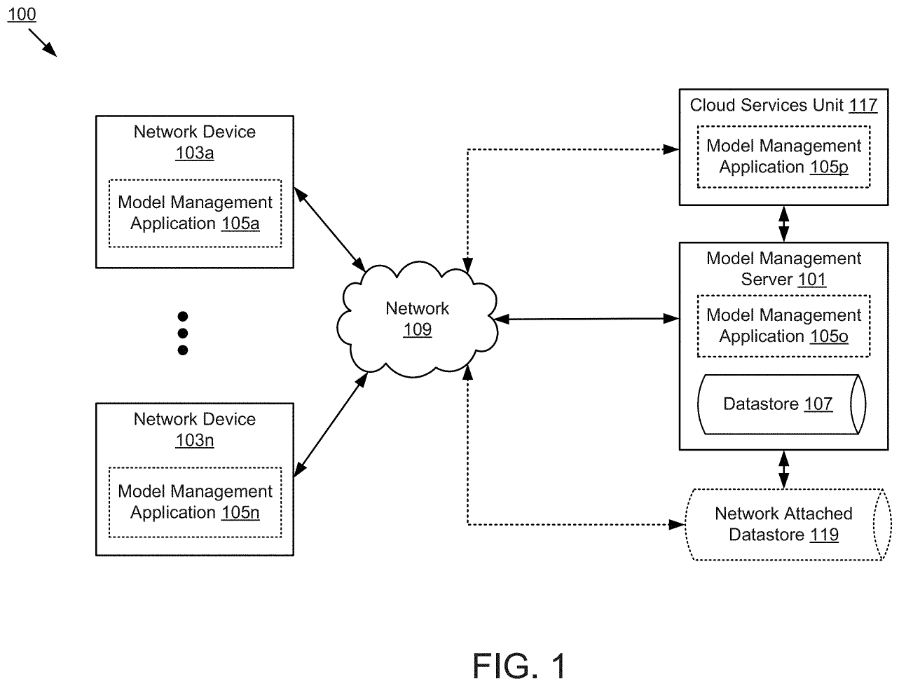

FIG. 1 is a block diagram of hardware components for a machine learning system, which may be also referred to as “model management system” due to its focus on the model development and training processes. As illustrated, the model management system 100 may be a network-based specialized computer environment configured to efficiently develop and deploy a set of machine learning models (may be simply referred to as “models”) or AI engines, which can be scaled to different domains and business needs across different platforms, devices, and modalities. As illustrated in FIG. 1, the model management system 100 may include one or more specialized computers or other machines that are configured to develop, train, and deploy machine learning models, and/or apply the deployed machine learning models (e.g., by reference engine) for content recommendation, auto-messaging, anomaly detection, user authentication, document classification, and many other applications.

In one embodiment, the model management system 100 includes one or more general network devices, such as edge devices 103 that may communicate with other components of the system through network 109. For example, edge devices 103 may collect and send data to the model management server 101 to be processed, and/or may receive machine learning models developed by the model management server 101, among other activities. In an edge computing network aimed to reduce the bandwidth costs associated with moving raw data form where it was either an enterprise data center or the cloud, edge devices are devices that connect to a nearby module for more responsive processing and smoother operations. In one example, edge devices 103 may include desktop computers, laptops, handheld or mobile devices, personal digital assistants, wearable devices, Internet of things (IoT) devices, network sensors, databases, embedded systems, virtual reality (VR)/augmented reality (AR) devices, or many other devices that may transmit or otherwise provide data to the model management server 101.

In some embodiments, in addition to collecting data to be transmitted as part of a model development project (e.g., collecting data for model training and testing purposes), edge devices 103 may also receive machine learning models developed by the model management server 101, and further apply the received machine learning models or AI engines for specific applications. For example, an edge device 103 may receive a machine learning model specifically developed for the edge device or a family of devices similar to the edge device 103. The edge device may apply the specifically developed machine model for applications. Since the machine learning model is specifically developed for the edge device or a family of devices that have similar device constraints, the machine learning model may be optimized during the model development and thus have a better performance than a machine learning model that is developed without considering constraints existing in the edge device 103.

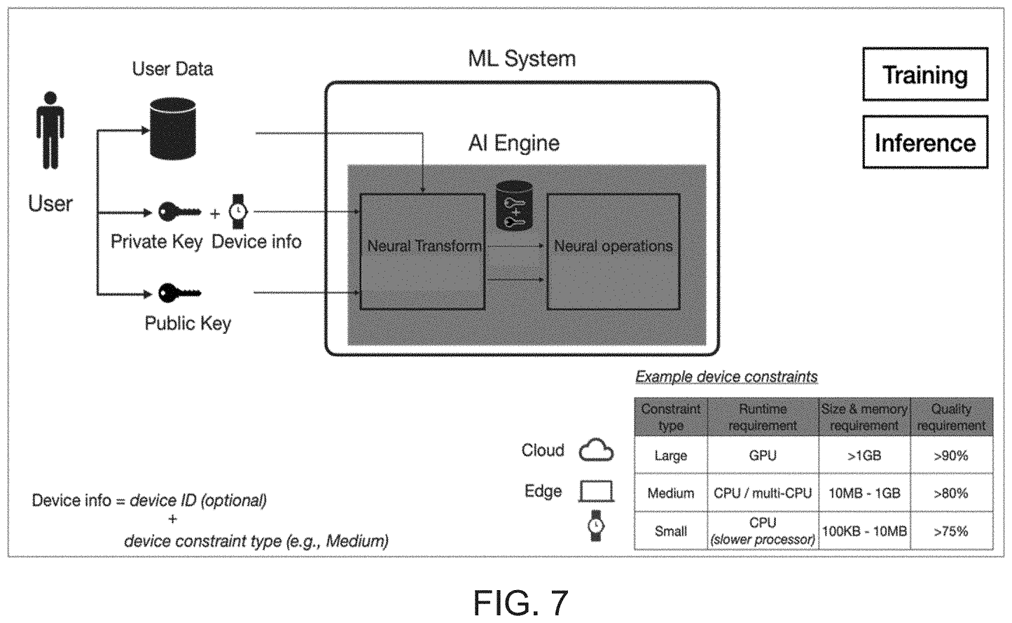

In some embodiments, edge devices 103 may be classified into different families based on the device constraints, such as processing capacity, runtime requirement, memory size, accessibility, and other properties of the devices, which generally reflect a computation power of a device. In some embodiments, the device constraints may also include the quality requirement (e.g., a score range) for the machine learning model output for the devices. In some embodiments, the edge devices 103 may be classified into three, four, five, or even a larger number of families, where each family may show a difference with respect to the device constraints. In one example, as illustrated in FIG. 7, the edge devices 103 may be classified into three families (i.e., large, medium, small) based on the device constraint type. An enterprise server for an enterprise or an edge server for an online service provider may be classified as a “large” edge device due to its quicker processor, larger memory size, and higher quality requirement. A wearable device or an IoT device and the like may be classified as a “small” edge device, due to its slower processor, smaller memory size, and lower quality requirement. A personal computer or laptop and the like may be classified as a “medium” edge device due to its decent processing capacity, memory size, and quality requirement.

In some embodiments, edge devices 103 may also perform processing on data they collect before transmitting the data to the model management server 101, or before deciding whether to transmit data to the model management server 101. For example, edge devices 103 may determine whether the collected data meets certain rules, for example, by comparing data or values calculated from the data to one or more thresholds. Edge devices 103 may use this data and/or comparisons to determine if the data should be transmitted to model management server 101 for data handling and/or processing (e.g., for inputting into machine learning models for training and/or testing). Data with or without processing may be transmitted by edge devices 103 directly to the model management server 101 or network-attached data store, such as network-attached datastore 119 for storage so that the data may be retrieved later by the model management server 101 or other components of the model management system 100.

The model management system 100 may also include one or more network-attached datastore 119. Network-attached datastore 119 may be configured to store data managed by the model management server 101 as well as any intermediate or final data (e.g., untrained or trained machine learning models) generated by the model management system 100 in non-volatile memory. However, in certain embodiments, the configuration of the model management server 101 allows its operations to be performed such that intermediate and final data results may be stored solely in volatile memory, without a requirement that intermediate or final data results (e.g., intermediate parameters and weights obtained during the model training processes) be stored in non-volatile types of memory, e.g., network-attached datastore 119.

Network-attached datastore 119 may store a variety of different types of data organized in a variety of different ways and from a variety of different sources. For example, network-attached datastore 119 may store unstructured (e.g., raw) data, such as social media, emails, messages, stock market charts, etc. The unstructured data may be presented to the model management server 101 in different forms such as a flat file or a conglomerate of data records, and may have data values and timestamps. The model management server 101 may be configured to analyze and/or annotate the unstructured data in a variety of ways to determine the best way to structure (e.g., hierarchically) that data, such that the structured data is tailored to a type of further analysis that a user wishes to perform on the data. For example, after being processed, the unstructured timestamped data may be aggregated by time (e.g., into daily time period units) to generate time series data (e.g., time series data for automotive applications) and/or structured hierarchically according to one or more dimensions (e.g., parameters, attributes, and/or variables). For example, data may be stored in a hierarchical data structure, or may be stored in a tabular form. In some embodiments, the analyzed or annotated data may facilitate the preparation of data for testing and/or training machine learning models developed by the model management server 101. In some embodiments, the data analysis and annotation may be performed on an edge device instead (e.g., on a model management application 105a/105n residing on an edge device 103a/103n), to minimize network consumption.

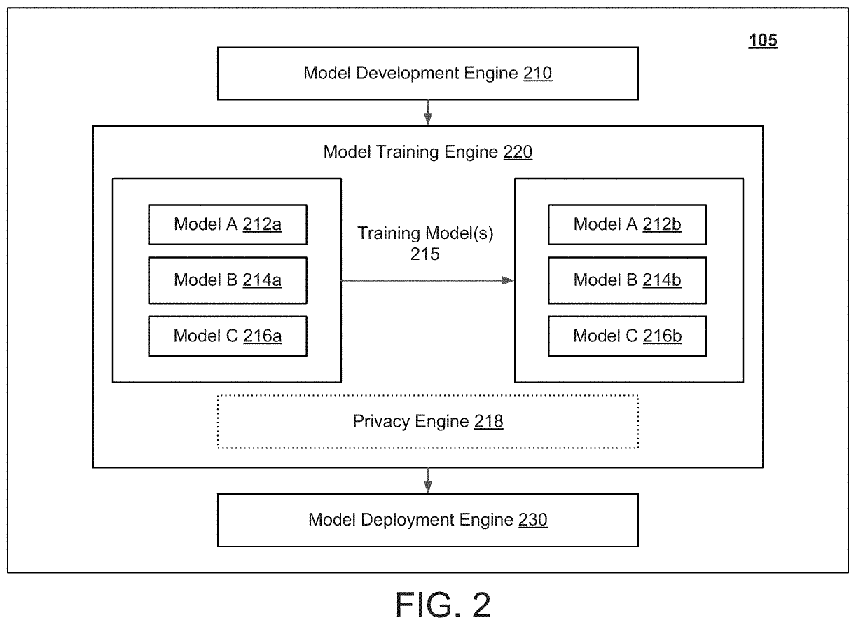

In some embodiments, besides data analysis and/or annotation, the model management server 101 may be configured to develop machine learning models customized based on the constraints of the edge devices, as described elsewhere herein. For example, the model management server 101 may include an instance of model management application 105o configured to develop a set of machine learning models that may have a similar application (e.g., fraud detection). The set of machine learning models may show a difference in performance (and thus also referred to as different tiers of models) due to the different complexities (e.g., different layers of neural network) of the developed machine learning models, although these models have a same expected application. These models with different performances may be deployed to edge devices 103 that have different processing capacities or device constraints. In some embodiments, the instance of model management application 105o may include one or more of model development engine, model training engine, or model deployment engine configured for model development, training, and further deployment, as further described in detail in FIG. 2.

In some embodiments, the edge devices 103 may also include a model management application 105a or 105n. The instance of model management application 105a or 105n may be similarly configured to develop one or more machine learning models. In some embodiments, besides model development and deployment, the instance of model management application 105a or 105n may be further configured to apply the machine learning models for specific applications. For example, the instance of model management application 105a or 105n may further include an inference engine configured to access a trained machine learning model and apply the model to process incoming data (e.g., text document) to generate a final output (e.g., a document category if the machine learning model is a document classifier). In some embodiments, an edge device 103 may be configured to merely include an inference engine without including a model development function, or vice versa.

In some embodiments, the model management system 100 may additionally include one or more cloud services units 117. Cloud services unit 117 may include a cloud infrastructure system that provides cloud services. In some embodiments, the computers, servers, and/or systems that make up the cloud services unit 117 are different from a user or an organization's own on-premise computers, servers, and/or systems. For example, the cloud services unit 117 may host an application (e.g., a model management application 105p), and a user may, via a communication network, order and use the application on-demand. In some embodiments, services provided by the cloud services unit 117 may include a host of services that are made available to users of the cloud infrastructure system on demand. For example, the services provided by the cloud services unit 117 may include machine learning model development, training, and deployment. Additionally or alternatively, the services provided by the cloud services unit 117 may merely include hosting trained machine learning models for use by online users. In some embodiments, the cloud services unit 117 may be also a server for providing third-party services, such as messaging, emailing, social networking, data processing, image processing, or any other services accessible to online users or edge devices. In some embodiments, the cloud services unit 117 may include multiple service units that each is configured to provide one or more of the above-described functions or other functions not described above.

In some embodiments, services provided by the cloud services unit 117 may dynamically scale to meet the needs of its users. For example, cloud services unit 117 may house one or more model management applications 105p for model development, training, and deployment, which may be scaled up and down based on the number and complexity of machine learning models being developed or to be developed. Accordingly, in one embodiment, cloud services unit 117 may be utilized by the model management server 101 as a part of the extension of the server, e.g., through a direct connection to the server or through a network-mediated connection.

Communications within the model management system 100 may occur over one or more networks 109. Networks 109 may include one or more of a variety of different types of networks, including a wireless network, a wired network, or a combination of a wired and wireless network. Examples of suitable networks include the Internet, a personal area network, a local area network (LAN), a wide area network (WAN), or a wireless local area network (WLAN). A wireless network may include a wireless interface or a combination of wireless interfaces. As an example, a network in one or more networks 109 may include a short-range communication channel, such as a Bluetooth or a Bluetooth Low Energy channel. A wired network may include a wired interface. The wired and/or wireless networks may be implemented using routers, access points, bridges, gateways, or the like, to connect devices in the system 100. The one or more networks 109 may be incorporated entirely within or may include an intranet, an extranet, or a combination thereof. In one embodiment, communications between two or more systems and/or devices may be achieved by a secure communications protocol, such as a secure sockets layer or transport layer security. In addition, data and/or transactional details may be encrypted (e.g., through symmetric or asymmetric encryption).

In some embodiments, the model management server 101 may further include a data store 107 configured for managing, storing, and retrieving data that is distributed to and stored in one or more network-attached datastores 119 or other datastores that reside at different locations (e.g., within an edge device) within the model management system 100.

It is to be noted that, while each edge device 103, server 101, and cloud services unit 117 in FIG. 1 is shown as a single device, it will be appreciated that multiple devices may be used instead. For example, a set of edge devices may be used to transmit various communications from a single user or different users, or the model management server 101 may include a server stack. As another example, data may be processed as part of the model management server 101. As yet another example, edge device 103 may be a part of the model management server 101, and cloud services unit 117 and/or network-attached datastore 119 may be not included in the model management system 100.

In addition, the functions included in each instance of model management application 105a/105n/105o/105p (together or individually referred to as “model management application 105”) in different device may be different. In some embodiments, different instances of application 105 from different devices collaboratively complete one or more functions. For example, one or more edge devices 103 and the model management server 101 may collaboratively train a machine learning model(s). In the following, model management application 105 included in the model management server 101, edge devices 103, or cloud services unit 117 will be described further in detail with reference to specific engines, modules, or components, and their associated functions.

FIG. 2 illustrates example components included in a model management application 105, according to embodiments of the disclosure. As illustrated in the figure, a model management application 105 may include a model development engine 210, a model training engine 220, and a model deployment engine 230. In some embodiments, a model management application 105 may further include an inference engine (not shown) that uses a trained machine learning model for application. It should be noted that not every model management application includes all engines 210-230. Depending on the residing device, a model management application 105 may include fewer components than those illustrated in FIG. 2. In one example, a model management server 101 may not include an inference engine, while an edge device 103 may only include an inference engine. In another example, an edge device 103 may include all components mentioned here.

The model development engine 210 may be configured to develop machine learning models for specific applications. Based on the purposes of specific applications, the machine learning models developed by the model development engine 210 may include a large number of machine learning model sets configured toward different applications. The possible applications for these machine learning models may include but are not limited to:
Content detection
Sentiment analysis—detecting sentiment (e.g., sentiment towards products expressed in customer reviews)
Emotion recognition—detecting an emotional aspect of user content (e.g., messages, tweets)
Document/posts/message/email categorization—(e.g., categorize news article or headline into business vs. sports vs. technology)
Anomaly detection—(e.g., identifying unusual activity in banking accounts)
Legal discovery
Product categorization (for shopping)—from text, image
Personalized object detection (from images, videos)
Content recommendation
News recommender system
Query understanding
Photo finder
Search (on personal devices)
Personalized auto-completion for messaging
Content filtering
Hate-speech detection—filter hateful content in social media (messages, tweets, etc.)
PII filtering—identify and remove personally-identifiable content from documents, transaction reports, etc.
Sensitive content detection—filter sensitive (or harmful) content from user-generated data (e.g., comments)
User and conversational AI (e.g., chatbots)
Intent detection—automatically recognize intent expressed in conversations between user-to-machine or user-to-user settings (e.g., I am interested in the new Macbook®→purchase intent)
Personalized virtual assistants—personalize smart home assistants while maintaining privacy (e.g., customize commands, smart actions, and execution routines for individual users).
User authentication—use user input/features to authenticate on a device
Fraud prevention—tackle payment and sensitive information fraud to detect and prevent fraud activities of information
Automated stock trading (e.g., AI-based high-frequency trading platforms)
Computer vision—derive meaningful information from digital images, videos, and other visual inputs
Discovery of data trends (e.g., use consumers' behavior to discover data trends)

The application scenarios of these machine learning models may relate to, but are not limited to the following: search, advertisements (Ads), messaging and email, shopping, social media, virtual assistants, smart home, automotive, augmented reality (AR)/virtual reality (VR), news, health, finance and law, HR integration systems, embedded systems, etc.

In some embodiments, the model development engine 210 may be configured to develop a set of machine learning models for a single specific application (e.g. document classification), as described elsewhere herein. Not like many other machine learning systems that focus on the operating systems of the target devices (e.g., developing different machine learning models for iPhone® and Android devices), the disclosed model development engine 210 is more focused on the device constraints associated with the target devices, among other possible factors (e.g., user information) that may also affect the model development. In one example, based on the device constraints, the model development engine 210 may develop, for a single application, a set of machine learning models that respectively fit the target devices with different constraints.

For example, the model development engine 210 may develop three or more machine learning models that have the same function but with different performances. Each of these machine learning models may be suitable for application in a subset of the target devices. For example, a first machine learning model may perform well on wearable devices that have limited processing capacity and memory size, and a second machine learning model may perform well on a personal computer, a laptop, a cell phone or tablet, or another device that has a decent processing capacity, and a third machine learning model may perform well on an enterprise server or cloud service-implementing device that has a much larger processing capacity and/or memory size. In some embodiments, based on how the device constraints of the target devices are categorized, the set of machine learning models may include three, four, five, six, seven, or even a larger number of machine learning models that have the same function (e.g., content classification). By increasing the number of machine learning models in each set, the performance of corresponding models may be improved, since there will be less gap in performance when there are more models developed for a same application.

In some embodiments, the model development engine 210 may first determine all possible target devices capable of running an application (or a trained AI engine), and then identify constraints among all possible target devices, but not other devices that are incapable of running the application. For example, if a set of machine learning models are being developed for an automotive-related application, only the devices (e.g., devices with necessary video, audio, and/or laser-detection sensors) that can be used for the automotive-related application are considered in identifying the constraints of the target devices. For another example, if a set of machine learning models are being developed for an AR/VR-related application, then the AR/VR devices, but not other devices, are evaluated in identifying the constraints of the target devices. Accordingly, when categorizing the device constraints, due to the possible different target devices for different applications, the criteria used in the categorizing process may be also different.

As described earlier, the machine learning models developed for target devices with different constraints may have different performances. This is mainly due to the complexity of the algorithms added to each model in the set of machine learning models. While some basic functions may be achieved through a basic algorithm, by including more complexity, the performance of an algorithm may be improved. For example, for objection detection from an image, a neuron network with three layers may achieve the basic function in object detection. However, by increasing the neuron network to five layers, the accuracy in object detection may be improved, due to additional features considered through the added two more layers in object detection. If the neuron network is further improved to include ten layers, the accuracy of the machine learning model in object detection can be further improved.

In some embodiments, the algorithm of machine learning models with different complexities may preferably match device constraints of applicable devices. Accordingly, each machine learning model in the developed set of machine learning models is expected to be deployed to a family of devices with the corresponding device constraints.

The model training engine 220 is configured to train the machine learning models developed by the model development engine 210. For instance, for a set of machine learning models developed by the model development engine 210, such as model A 212a, model B 214a, and model C 216a, each model may be trained through a model training process 215, to obtain the trained model A 212b, model B 214b, and model C 216b, as illustrated in FIG. 2. Depending on the application, the machine learning model, and the available data for training, different training processes may be used by the model training engine 220. For example, the training process 215 can be supervised, semi-supervised, or unsupervised training. In one example, the training of a neural network includes feeding the neural network with input data, and adjusting the values of the elements of the weight arrays W₁, W₂, . . . Wₙ and/or bias vectors b₁, b₂, b₃, . . . bₙ, so that the output of the neural network is closer to the required output for the input data. This is repeated many times (e.g., iterations) until the neural network is properly trained (e.g., model weights are finalized when there is not much decrease in error).

In some embodiments, the model training process can be implemented on an edge device 103, the model management server 101, or the cloud services unit 117. For a machine learning model trained on the model management server 101 or the cloud services unit 117, due to the availability of a high-performance computing platform, the same set of machine learning models developed for devices with different constraints can be all trained on the model management server 101 or the cloud services unit 117. For a machine learning model trained on an edge device 103 that has limited computation power, only a model corresponding to its device constraints or devices having greater constraints may be trained on that edge device, while the other models in the model set are not trained on that edge device 103. For example, a “medium” device may be used to train models for “medium” or “small” devices, while a “small” device may be only used to train models for “small” devices.

In some embodiments, to acquire a proper model for training on the edge device 103, the edge device information (e.g., hardware information) along with input specifications (which may indicate which kind of application) may be transmitted to the model management server 101. Depending on the device information and input specification, the model management server 101 may select (or instantiate one if there is no existing one) a machine learning model suitable for the device type. For example, if the edge device is a GPU machine running on a desktop, the model management server 101 may select a machine learning model that uses a lot of parameters, e.g., a model for neural transform operations (e.g., text documents are transformed from string inputs to byte/bit-encoding representations) that use a large number of bits and have a big architecture (e.g., 100 million or billion parameters). On the other hand, if the edge device is a mobile phone with much smaller computation and memory capacity, the model management server 101 may select a model that uses fewer parameters, e.g., a model for faster neural transform operations coupled with a smaller set of parameters (e.g., 100,000). The selected machine learning model may have architecture and weights optimized for training on the edge device with the corresponding constraints, and thus may operate smoothly (e.g., with little response time) once deployed to the corresponding edge device.

In some embodiments, a machine learning model may be cooperatively trained by two or more different devices. For example, to train a machine learning model inside an edge device 103 that has a limited computational capacity in model training, the edge device may send the device information (e.g., device ID) along with other input specifications into the model management server 101, which may select and train a machine learning model locally to obtain a set of weights for the model architecture. The obtained weights may be then transmit back to the edge device 103 for parameter integration to obtain a trained machine learning model on the edge device.

In some embodiments, a machine learning model may be further trained by including private user information to obtain a private machine learning model (or personalized model). That is, a trained machine learning model is not only device-specific but can be also user-specific. Towards this objective, the model training unit 220 may optionally include a privacy engine 218 configured to train a machine learning model with provided user information (e.g., user identification information) and optionally application information so that the model weights are optimized for the specific user and application. For example, a personalized content detection or recommendation engine, if trained with user information, may filter messages or social media posts, tweets, and the like based on user information (e.g., user preferences) and surface only posts that pertain to user-interested topics (e.g., crypto).

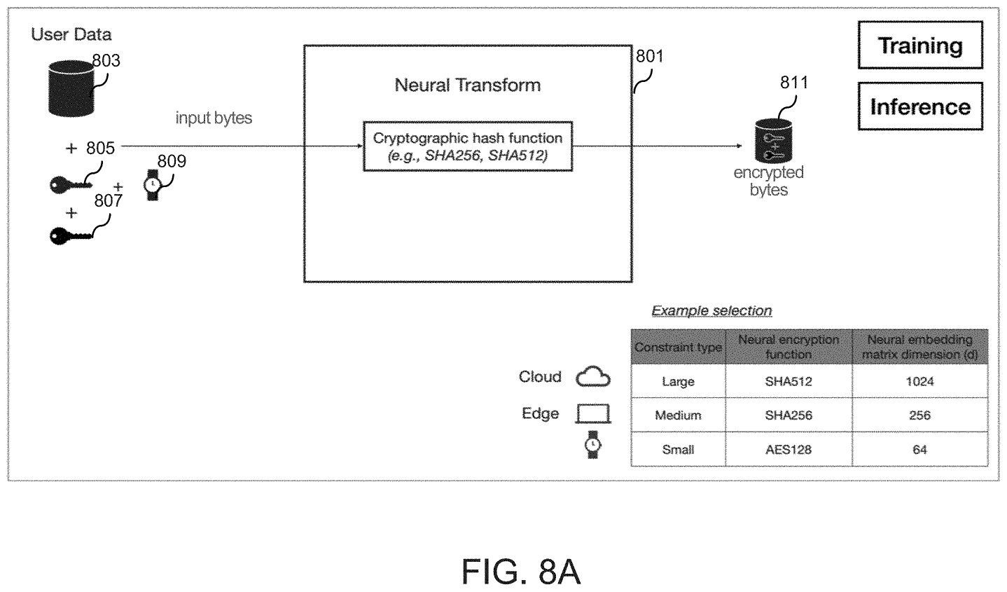

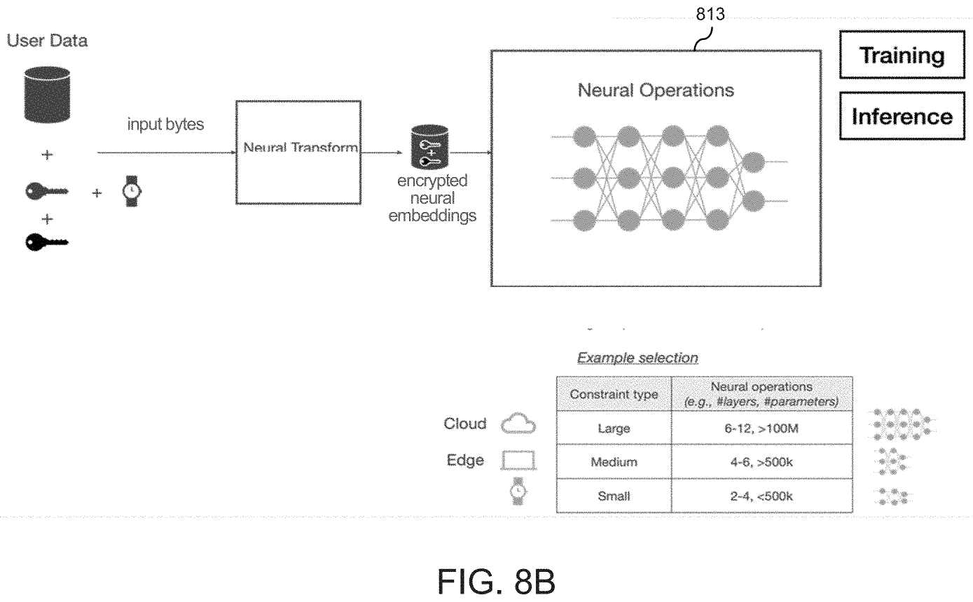

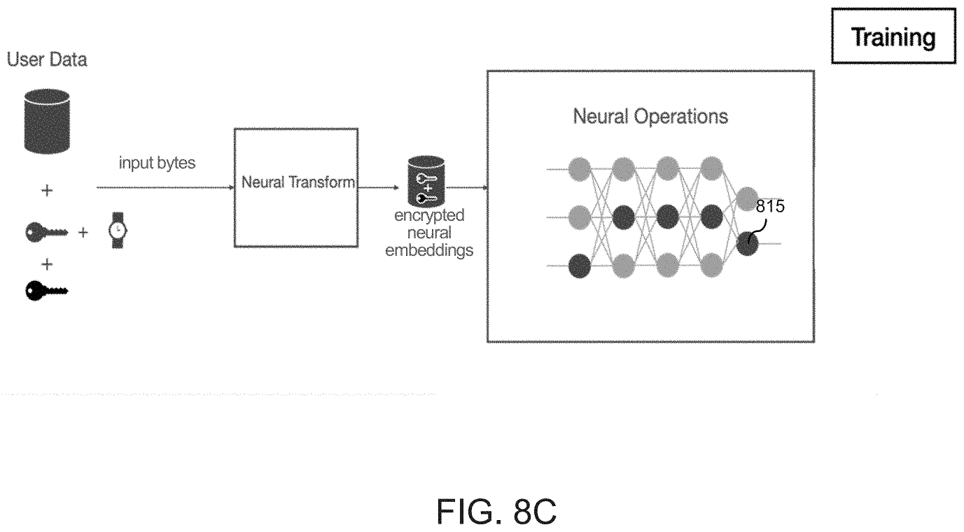

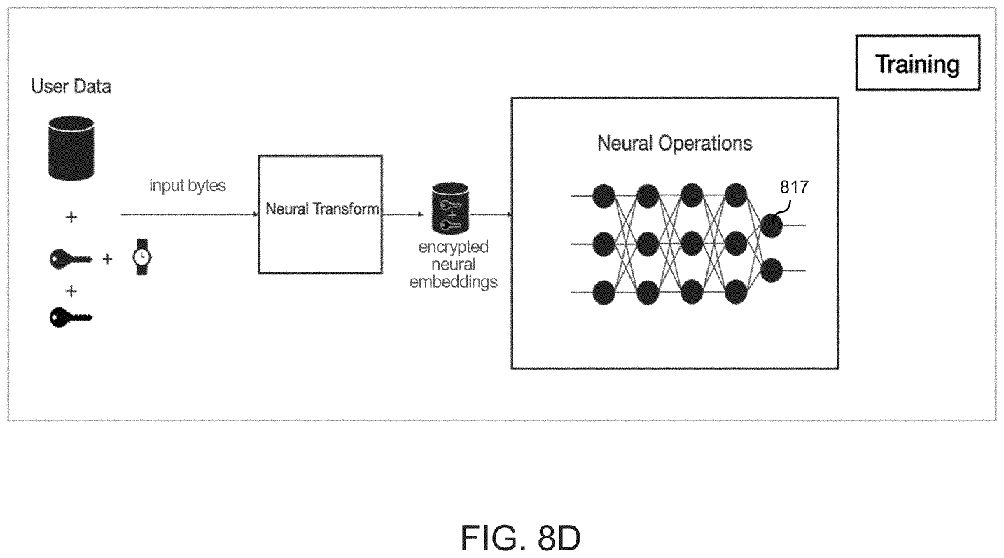

Under certain circumstances, multiple different users may train and personalize the machine learning models on individual data and specific applications to produce different and private versions of the AI engine tailored to their individual needs. For example, user A may train a topic detection system to narrow down and recognize posts specifically related to “baseball,” whereas user B may train the engine to surface tennis-related posts instead. All other generic users may see posts about broader topics (e.g., sports or politics in general) if the AI engine is not trained with personal information for these users. As another example, an enterprise with multiple divisions may use the privacy engine 218 to train different AI engines (i.e., different versions of a machine learning model) that cater to different cohorts of customers. The enterprise may then choose to grant/deny certain divisions access to the AI engine in a selective manner using the private sharing option. For example, a customer service chatbot can be trained and accessed by the finance division to help with banking or payment issues, whereas the same chatbot can be also trained and used by the IT division to respond differently to IT/technical issues. As a result, once trained, the AI engine is automatically and natively privacy-preserving. The specific processes of training a personalized AI engine are further described in detail in FIGS. 7-8D.

The deployment engine 230 may be configured to deploy a machine learning model to a target device. The machine learning model for deployment can be a trained machine learning model or an untrained machine learning model, as described above. When deploying a machine learning model to a target device (e.g., an edge device), the deployment engine 230 may first check the constraints of the target device. The deployment engine 230 then selects a proper machine learning model developed by the model development engine 210 (with or without training by the model training engine 220) based on the constraints of the target device. In some embodiments, if a machine learning model is developed and/or trained on an edge device 103, the machine learning model can be directly deployed on the edge device, or to another cloud or edge device.

In some embodiments, a machine learning model developed and/or trained on an edge device 103a can be also deployed to another edge device 103b that has similar constraints. For example, a machine learning model developed on a desktop computer may be deployed to a laptop that may have similar constraints.

In some embodiments, if the target device is an edge device (e.g., an edge device), a deployed machine learning model may have:
no communication with the cloud device, running entirely on the edge device and generating predictions for data passed as input from a user device;
intermittent one-way communication, for example from the model management server to the edge device, to update the machine learning model (also referred to as “edge model” if it is deployed to an edge device) whenever a new version is available, or when the user or device constraints change or there is a change in the input data; and/or
two-way communication between the model management server and the edge device—for example, if the edge device detects some changes in data or prediction quality, the edge device may preemptively communicate with the model management server to start training a new model. In this scenario, the model management server or the edge device does not need to send any user data to the other side (e.g., for a personalized model), instead, the edge device only needs to send relevant metadata or information that enables the machine learning model to be trained and updated accordingly.

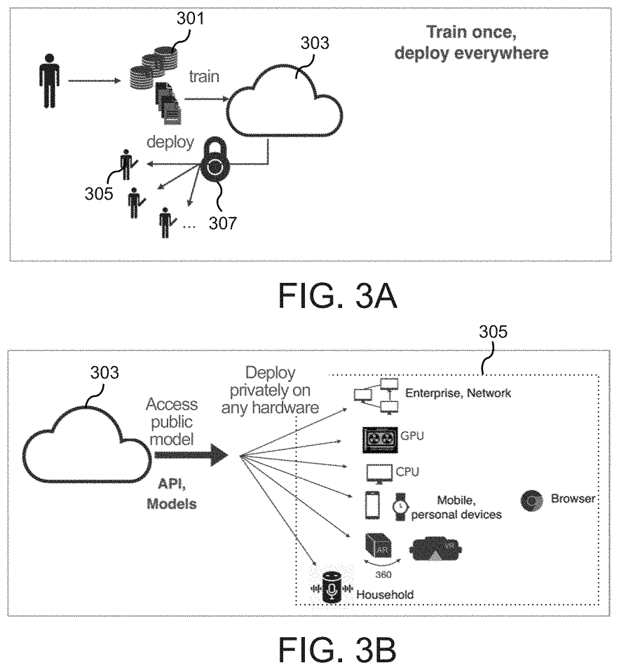

In some embodiments, a deployed machine learning model may be further customized by a user, enterprise, application, device, or a combination thereof. For example, a machine learning model developed by the model management server 101 for a specific edge device 103 may be further optimized for system choices such as privacy, personalization, modeling and/or efficiency, so that the deployed machine learning model can adapt to the specifications of a given application scenario. The specific processes for model deployment as well as model development and training are further described with reference to different application scenarios, as further illustrated in FIGS. 3A-6.

FIG. 3A illustrates an example scenario where machine learning models are trained once and deployed to various devices. As illustrated, data and annotations 301 for training machine learning models may be obtained to train the machine learning models in a cloud server 303. Once trained, the machine learning models may be deployed anywhere. The deployed machine learning models may be private (e.g., personalized model delivered to a specific device or user), as indicated by lock 307 in FIG. 3A.

FIG. 3B illustrates an example scenario where machine learning models are deployed to various devices. As illustrated, the machine learning models may reside on a cloud server 303 and may be deployed to a large variety of edge devices 305, such as enterprise server, GPU, CPU, mobile personal devices, browser, AR/VR, or household device, as illustrated in FIG. 3B.

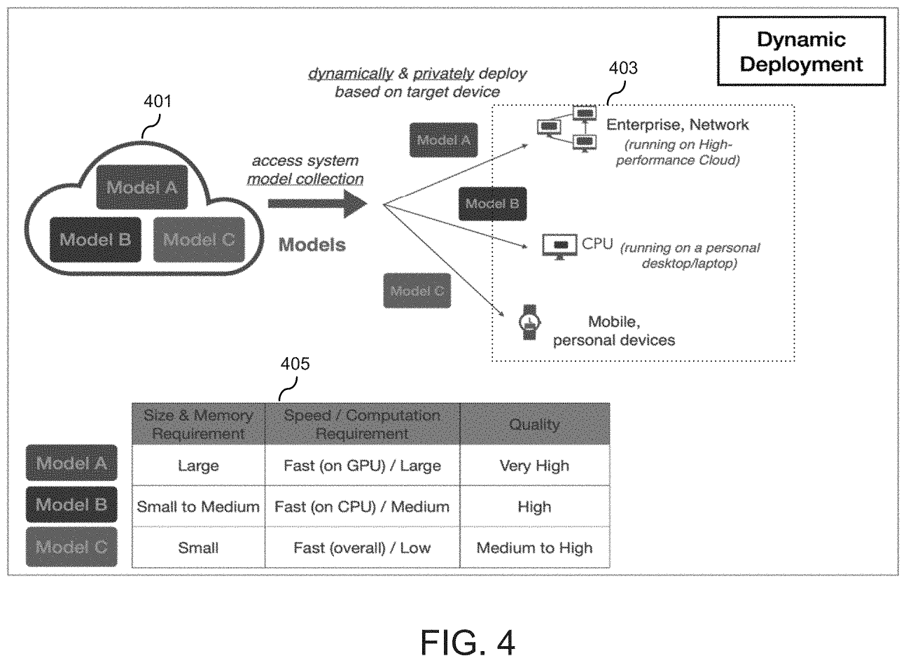

From FIGS. 3A-3B, it can be seen that the present disclosure provides a solution for training and deploying machine learning models to different domains and business needs across different platforms, devices, and modalities. Although not illustrated in FIGS. 3A-3B, the deployment of machine learning models may be based on the constraints of different devices, as further illustrated in FIG. 4.

FIG. 4 illustrates an example scenario where machine learning models are dynamically and privately deployed based on the constraints of target devices. As illustrated, a cloud server 401 (which may be a model management server as described earlier) may host a set of machine learning models, such as model A, model B, and model C. The set of models may have the same application (e.g., content detection or another application) and may be developed for target devices 403 that have different constraints. For example, as shown in table 405 in FIG. 4, model A may be developed for a device that has a large memory size, a fast speed on GPU and a large computation capacity, and the quality of model output is very high. An enterprise server running on a high-performance cloud may satisfy such requirements, and thus model A may be dynamically deployed to the enterprise server once a request is received from that enterprise server. For model B, it is developed for a device that has a small to medium memory size, a fast speed, and a medium computation capacity, and the quality of the model output is high. A CPU running on a personal desktop/laptop may satisfy such requirements, and thus model B may be dynamically deployed to a desktop/laptop once a request is received from that desktop/laptop. For model C, it may be developed for a device that has a small memory size, a fast speed overall and a low computation capacity, and the quality of the model output is medium to high. A mobile personal device (e.g., a wearable device) may satisfy such requirements, and thus model C may be dynamically deployed to a mobile personal device once a request is received from that device. In some embodiments, the deployment of each model A, model B, or model C is considered a private deployment, since the model delivery may not apply to another different device.

In some embodiments, the cloud server 401 may host a large number of sets of machine learning models, where each set may have different applications. In addition, each set may have a different number of tiers of models, according to some embodiments. For example, the first set may have three machine learning models for a first application, the second set may have five machine learning models for a second application, and the third set may have four machine learning models for a third application. In some embodiments, the quantity of the models in each set is determined based on the device information for the devices capable of running a specific application. For example, the first set of models may be capping of running on wearable devices or embedded systems, and thus may include three models, while the second set of models may be capable of running on any edge devices, and thus may include five models, etc.

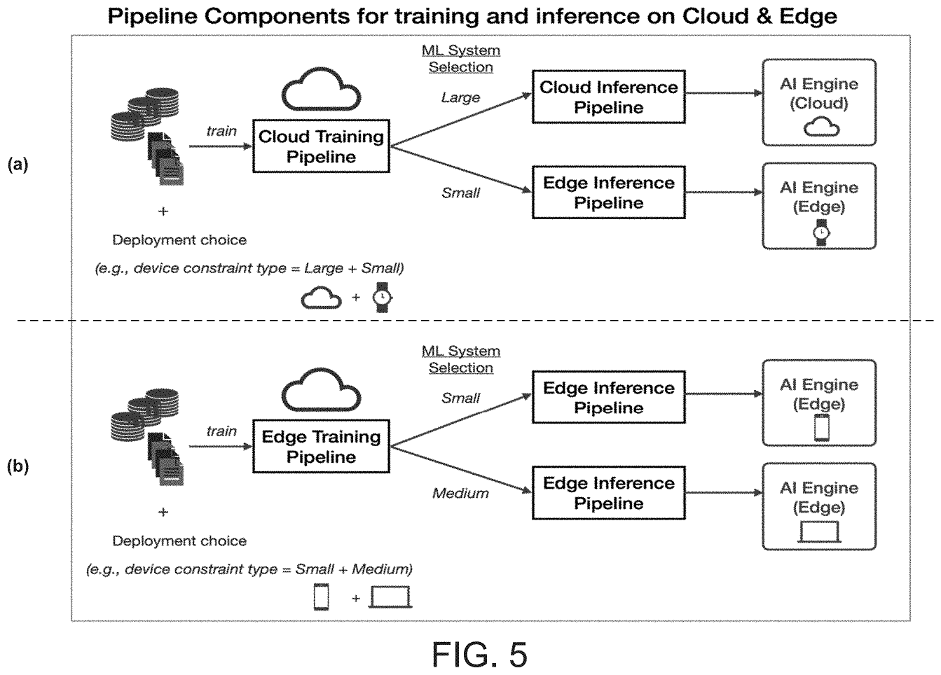

FIG. 5 further illustrates pipeline components for training and inference on cloud devices (or simply “cloud” as shown in FIG. 5) and edge devices (or simply “edge” as shown in FIG. 5), according to some embodiments. In part (a) of FIG. 5, models are developed and trained on a cloud device through a cloud training pipeline (which may be a model training engine 220 on cloud device). Based on the target device, the models may be accessed through a cloud inference pipeline or an edge inference pipeline. In part (b) of FIG. 5, models are developed and/or trained on an edge device through an edge training pipeline (which may be a model training engine 220 on edge device). Only the edge inference pipeline is employed since the target devices are small and medium devices. The specific functions and processes of the cloud training pipeline, edge training pipeline, cloud inference pipeline, and edge inference pipeline are further illustrated in detail below, with certain features having been described earlier with reference to different engines in FIG. 2.

Cloud training pipeline refers to a machine learning system on the cloud (e.g., the model management server) that computes and processes raw input data (e.g., document text, images, speech) and any provided annotations (e.g., labeled categories relevant for the input and task). The machine learning system may include a deep neural network whose model weights are optimized and tuned on the provided data and annotations to produce highly accurate predictions for the particular application (e.g., document categorization). In some embodiments, the machine learning system may include a collection of multiple deep neural network models, and a particular one is chosen dynamically based on the application, deployment strategy, and customer needs. In one embodiment, the collection of deep neural network models is chosen based on the end-user task. For example, if the task for the machine learning system is to classify text documents into topic categories, the cloud training pipeline may instantiate and train (either jointly or separately) a collection of multiple deep neural network classifiers that are optimized to achieve different levels of performance along different dimensions like speed, memory, size, accuracy, etc. The number and choice of models added to this collection (on the cloud) may depend on the target devices and corresponding deployment constraints. For example, if the goal is to deploy to: (1) an API running on cloud GPU, (2) a laptop, and (3) a smart wearable device, the cloud training pipeline may train three tiers of models ranking from small to large and add them to the collection. At deployment time, depending on the device constraints of the device sending the request, the corresponding model is selected based on the constraints of the target device (e.g., the fastest and smallest model chosen for the smart wearable device).

Edge training pipeline refers to a machine learning system on an edge device (or edge network) that computes and processes raw input data (e.g., document text, images, speech) and any provided annotations (e.g., labeled categories relevant to the input and task). The machine learning system may include a deep neural network whose model weights are optimized directly on the edge device to perform on-device training on the provided data to produce accurate predictions for the particular application (e.g., document/image/speech categorization). The edge training pipeline may be hosted and run on an edge device, IoT, or private device like mobile phones, wearable devices (e.g., smart watches, health devices), laptops, browsers, smart appliances (e.g., smart refrigerators), smart home devices (e.g., virtual assistants), or private edge network.

The edge training pipeline implements deep neural network models that are optimized for the edge devices and are highly efficient (i.e., require smaller storage, memory, and computational resources), making it possible to train on edge devices, which is otherwise infeasible since these devices do not have access to large computational and memory resources compared to high-performance cloud computing platforms. The edge training pipeline may achieve this by passing the target edge device information along with other input specifications to the cloud server (e.g., model management server). The cloud server may select and optimize the selected model for the specific task and the corresponding edge device. For example, if the edge device for model deployment and training is a GPU machine running on a desktop, the cloud server chooses neural transform operations that use a large number of bits and a big architecture. On the other hand, if the edge device is a mobile phone, the cloud server may choose a faster neural transform coupled with a smaller set of parameters. This may yield a machine learning model that runs fast, is small in size, and requires low-cost resources which can be targeted based on the user needs, task, and device constraints. When the selected model is deployed and trained on the edge device, the model architecture and weights may be optimized for the constraints of the edge device. Once trained, the model can be deployed directly on the edge device that has a lower capacity than high-performance cloud platforms. In some embodiments, the models trained through the edge training pipeline may be deployed to other edge devices that have similar or greater device constraints.

Cloud inference engine refers to an inference engine running on the cloud that accesses a trained machine learning model and uses it to process the incoming input (e.g., text document) to produce a final prediction-processed output (e.g., document category if the purpose of the application is to classify the document) and relevance scores (e.g., the quality of the model output). The output may be displayed through a user interface or returned to the application via a cloud application programming interface (API).

Edge inference engine refers to an inference engine running on an edge device that accesses a trained machine learning model and uses it to process the incoming input (e.g., text document) to produce a final prediction-processed output (e.g., document category) and relevance scores. The output may be returned to the application or displayed directly on the user device via a local (device) API, an app, or a browser.

Referring back to FIG. 5, in an application scenario in part (a), the device constraint types for the target devices (e.g., large and small) may be submitted to the cloud training pipeline in the cloud, which selects the proper tiers of models corresponding to the device constraint types. The selected tiers of models are trained through the cloud training pipeline. The trained models may be then deployed to the target devices and accessed through the cloud inference pipeline or edge inference pipeline. For example, the model corresponding to the “large” device constraint type is deployed to a cloud server and can be accessed through the cloud inference pipeline, while the model corresponding to the “small” device constraint type is deployed to a wearable device and can be accessed through an edge inference pipeline, as shown in part (a) of FIG. 5.

In an application scenario in part (b) of FIG. 5, the device constraint types for the target devices (e.g., medium and small) may be submitted to an edge device through the edge training pipeline instead. When using the edge training pipeline, the device information is submitted by the edge device to a cloud server (e.g., model management server), which then selects the proper tiers of models corresponding to the device constraint types. The selected tiers of models may be optimized based on the device constraint types of the target devices. The selected models may be then sent back to the edge device for training through the edge training pipeline. The trained models may be then deployed to the target devices and accessed through the edge inference pipeline. For example, the model corresponding to the “medium” device constraint type is deployed to a laptop and can be accessed through the edge inference pipeline, and the model corresponding to the “small” device constraint type is deployed to the mobile phone and can be accessed through the edge inference pipeline, as shown in part (b) of FIG. 5.

It is to be noted that the application scenarios in FIG. 5 are provided for exemplary purposes and not for limitations. In some embodiments, there are additional applications scenarios for the disclosed model management systems.

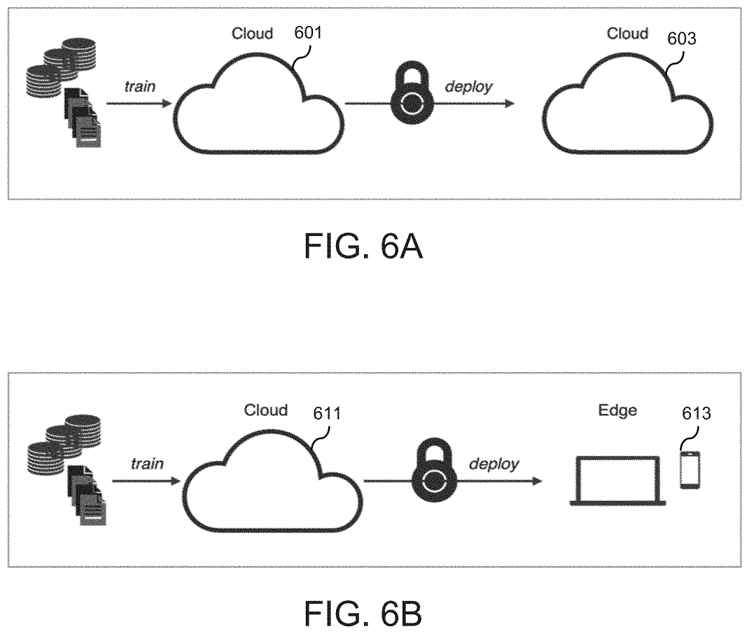

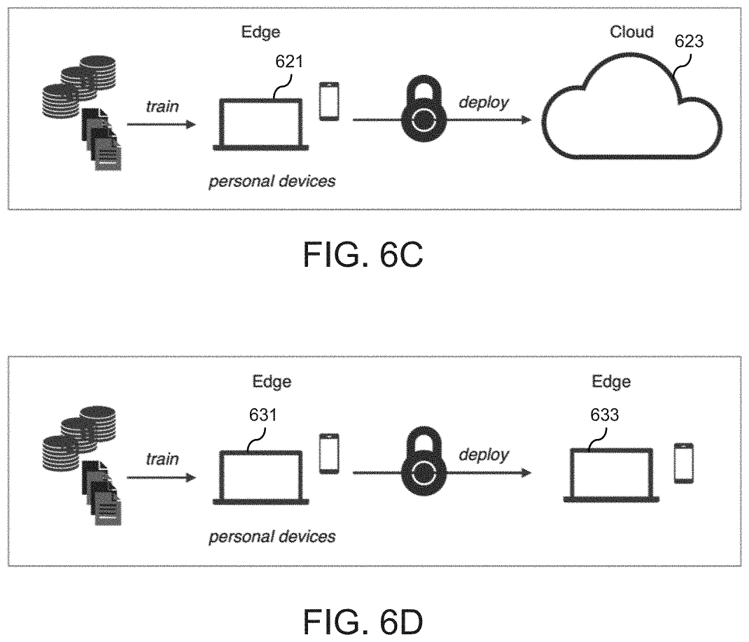

FIGS. 6A-6D illustrates representative application scenarios for the disclosed model management system. Specifically, FIG. 6A illustrates an application scenario where a machine learning model is trained on cloud device 601 and deployed to another cloud device 603. The first cloud device 601 may be a cloud server for model development and training services, where a plurality of sets of models for different applications may be developed and trained therein. The second cloud device 603 may be a cloud server that offers a specific application service, in which a trained model may be included therein and accessible to online users for a specific application (e.g., document classification).

FIG. 6B illustrates an application scenario where a machine learning model is trained on a cloud device 611 and deployed to an edge device 613. The cloud device 611 may develop a machine learning model corresponding to the device constraint type of the target edge device 613, and deploy the trained machine learning model to edge device 613 after the model training process, as discussed elsewhere herein.

FIG. 6C illustrates an application scenario where a machine learning model is trained on an edge device 621 and deployed to a cloud device 623. In this scenario, the model may be trained on the edge device through the edge training pipeline as described in FIG. 5, and then deployed to the cloud 623. The edge device 621 may be a personal device for a model developer and the cloud device 623 may be a private enterprise server serving the employees in an enterprise and may be a public server accessible to the public.

FIG. 6D illustrates an application scenario where a machine learning model is trained on edge device 631 and deployed to another edge device 633. In this scenario, the model may be trained on the edge device 631 through the edge training pipeline as described in FIG. 5, and then deployed to the other edge device 633. The edge device 631 may be a personal device for a model developer and the edge device 633 may be an edge device for running the model for a specific application. In one example, the edge device 633 may be an AR/VR device.

In some embodiments, the model training and/or deployment is not only device-specific, but can be also user-specific, as described earlier in FIG. 2. To be user-specific, the user information may be included in a training process, so that when a model is trained, the weights, biases, and other parameters may be tuned to be more user-specific, so that the output of the trained model is more user-focused when comparing to an AI engine generic to normal users.

FIG. 7 illustrates an example scenario where a machine learning model is trained with user information. As can be seen in the figure, when training the model, beyond the device information (e.g., device constraint type and/or device ID which may allow identifying device constraints), the user information such as the user data reflecting user preferences as well as the private key for the user may be also provided for training the model, to obtain a personalized AI engine.

If a different user or someone else without the exact user information (e.g., user-id) tries to access the personalized AI engine, the AI engine does not generate valid predictions (or the AI predictions become unusable). In some embodiments, even if another user (or someone from a different enterprise division) gains access to the device (or cloud cluster) storage or memory, the AI engine will not generate the right predictions for incoming data (for example, the accuracy of the AI engine when accessed without the right user-id/password can drop from 95% to 10% or lower, making it worse than chance or random guessing). As a result, the AI engine will be rendered useless to the attacker.

It is to be noted that, in some embodiments, the generated personalized AI engine may also have different tiers that correspond to different device constraint types. In one example, a personalized AI engine may include three tiers of machine learning models corresponding to different device constraint types as illustrated in FIG. 7. When the different tiers of models are deployed to different devices with different constraints, a user can then access personalized AI engine from these different devices, e.g., from a wearable device, a desktop computer, or from online access to a personalized cloud AI engine. The specific process for generating a personalized AI engine is further described in detail in FIGS. 8A-8D.

FIG. 8A illustrates an example process for providing personalized information to an AI engine 801, according to some embodiments. As illustrated, the personalized information may include user data 803 for training the machine learning model. The user data may reflect user preferences, user interests and other user-specific features, and thus may allow the AI engine to be tuned toward the user interests if the user data is used for training. A private key 805 and a corresponding public key 807 for public key cryptography are also provided for training. Device constraint type or device information 809 may be also provided so that a generated AI engine has a proper model tier (e.g., a small personalized AI engine for a wearable device).

As also illustrated, the AI engine (which may perform neural transform operations as illustrated in FIG. 8A) may include a cryptographic hash function for implementing the public key cryptography. In one example, through the cryptographic hash function (e.g., via SHA256, SHA512 or another hash algorithm), the byte sequence of the received input data may be encrypted via combined key using byte+context values into encrypted bytes in a neural embedding table. The resulting encrypted bytes may be represented as a “neural embedding matrix” 811, which may be further embedded into the neural transform operations during the training process.

FIG. 8B illustrates an example process for embedding encrypted bytes into neural operations, according to some embodiments. As illustrated, neural operations may include multiple layers of linear & non-linear neural operations 813, during which processes, the encrypted bytes may be dynamically embedded during the training process to obtain the multi-layer neural network parameters. During the training process, the choices of operations & output may depend on the prediction task. For example, for binary text classification, the network may generate a single output value between 0 and 1.

FIG. 8C illustrates an example training iteration to obtain partial network weights (as indicated by darker dots 815), according to some embodiments. During the training, network weights may be iteratively optimized and personalized for the user via the key(s) and the corresponding neural transform operations performed in the previous iteration. In one example, gradient descent may be used to optimize the network weights based on the user-provided labeled data and personal user data using the backpropagation algorithm.

FIG. 8D illustrates an example trained neural network for a personalized AI engine, according to some embodiments. As illustrated, through multiple iterations, the network weights for the neural network are optimized and finalized, as indicated by the dark bots 817 in FIG. 8D. The as-trained AI engine is a personalized engine, as the network weights are tied to the specific user. In some embodiments, relevant predictions from the AI engine may only be unlocked with the password that was originally used to customize the model.

Although not illustrated, the generated AI engine is also device-specific and has a model tier that matches the device constraint type, as the device information is fed into the training process, as illustrated in FIGS. 8A-8B.

The above-described various application scenarios are provided for illustrative purposes and not for limitations. In some embodiments, the various components 210, 220, 218, and 230 in the model management application 105 may implement these various applications and associated pipelines. In some embodiments, the above-described various application scenarios may be implemented on a computing system with access to a hard disc or remote storage, as further described in detail.

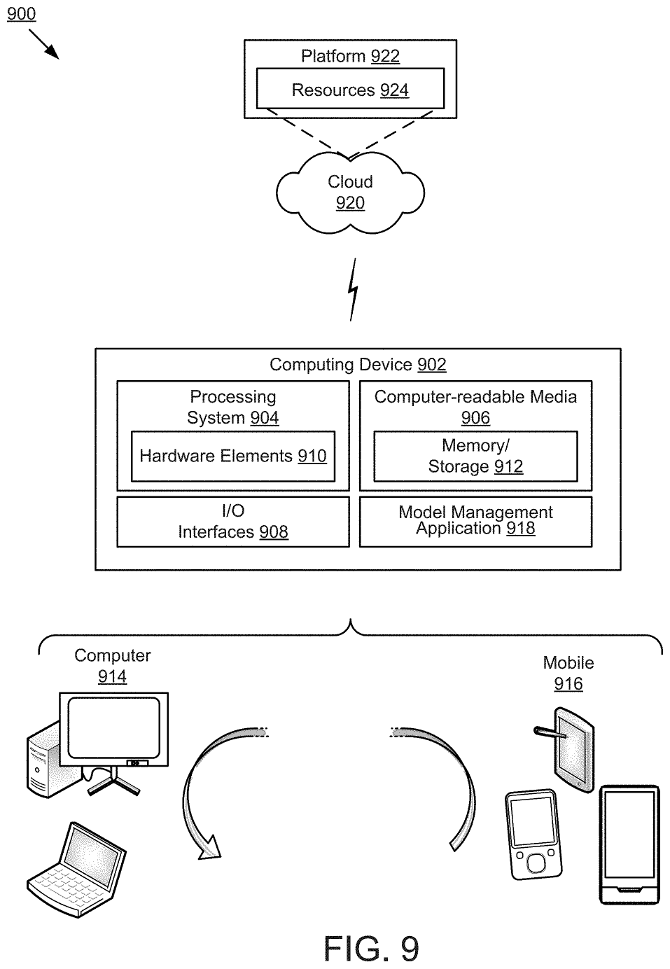

FIG. 9 illustrates an example system 900 that, generally, includes an example computing device 902 that is representative of one or more computing systems and/or devices that may implement the various techniques described herein. The computing device 902 may be, for example, an edge device 103, a cloud services unit 117, or a model management server 101 as shown in FIG. 1, an on-chip system embedded in a device (e.g., IoT), and/or any other suitable computing device or computing system.

The example computing device 902 as illustrated includes a processing system 904, one or more computer-readable media 906, and one or more I/O interfaces 908 that are communicatively coupled, one to another. Although not shown, the computing device 902 may further include a system bus or other data and command transfer system that couples the various components, from one to another. A system bus may include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of the functionality to perform one or more operations using hardware. Accordingly, the processing system 904 is illustrated as including hardware element 910 that may be configured as processors, functional blocks, and so forth. This may include implementation in hardware as an application-specific integrated circuit (ASIC) or other logic devices formed using one or more semiconductors. The hardware elements 910 are not limited by the materials from which they are formed, or the processing mechanisms employed therein. For example, processors may be comprised of semiconductor(s) and/or transistors, e.g., electronic integrated circuits (ICs). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random-access memory (RAM)) and/or nonvolatile media (such as read-only memory (ROM), Flash memory, optical disks, magnetic disks, and so forth). The memory/storage component 912 may include fixed media (e.g., RAM, ROM, a fixed hard drive, and so on) as well as removable media, e.g., Flash memory, a removable hard drive, an optical disc, and so forth. The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movements as gestures that do not involve touch), and so forth. Examples of output devices include a display device (e.g., a monitor or projector), speakers, a printer, a network card, a tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “unit,” “component,” and “engine” as used herein generally represent software, firmware, hardware, or a combination thereof. The features of the techniques described herein are platform-independent, meaning that the techniques may be implemented on a variety of commercial computing platforms having a variety of processors.

As previously described, hardware elements 910 and computer-readable media 906 are representatives of modules, engines, programmable device logic, and/or fixed device logic implemented in a hardware form that may be employed in one or more implementations to implement at least some aspects of the techniques described herein, such as to perform one or more instructions. Hardware may include components of an integrated circuit or on-chip system, an ASIC, a field-programmable gate array (FPGA), a complex programmable logic device (CPLD), and other implementations in silicon or other hardware. In this context, hardware may operate as a processing device that performs program tasks defined by instructions and/or logic embodied by the hardware as well as hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of an engine that is executable by the computing device 902 as software may be achieved at least partially in hardware, e.g., through the use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

As further illustrated in FIG. 9, the example system 900 enables ubiquitous environments for providing one or more device-specific AI engines, which can be further personalized. This improves the performance of an AI engine not only due to its compatibility with specific device constraints but also due to its personalized output.

In the example system 900, multiple devices are interconnected through a central computing device. The central computing device may be local to multiple devices or may be located remotely from the multiple devices. In one embodiment, the central computing device may be a cloud of one or more server computers that are connected to multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a family of target devices is created, and experiences are tailored to the family of devices. A family of devices may be defined by physical features, types of usage, or other common characteristics of the devices.

In various implementations, the computing device 902 may assume a variety of different configurations, such as for computer 914 and mobile 916 uses, and for many enterprise use, IoT user, and many other uses not illustrated in FIG. 9. Each of these configurations includes devices that may have generally different constructs and capabilities, and thus the computing device 902 may be configured according to one or more of the different device classes. For instance, the computing device 902 may be implemented as the computer 914 family of a device that includes a personal computer, desktop computer, multi-screen computer, laptop computer, netbook, and so on. The computing device 902 may also be implemented as the mobile 916 family of device that includes mobile devices, such as a mobile phone, a portable music player, a portable gaming device, a tablet computer, a wearable device, a multi-screen computer, and so on. In some embodiments, the devices may be classified according to their constraints instead, as described earlier.

The techniques described herein may be supported by these various configurations of the computing device 902 and are not limited to the specific examples of the techniques described herein. This is illustrated through the inclusion of a model management application 918 on the computing device 902, where the model management application 918 may include different units or engines as illustrated in FIGS. 1-2. The functionality represented by the model management application 918 and other modules/applications may also be implemented all or in part through the use of a distributed system, such as over a “cloud” 920 via a platform 922 as described below.

The cloud 920 includes and/or is representative of platform 922 for resources 924. The platform 922 abstracts the underlying functionality of hardware (e.g., servers) and software resources of the cloud 920. Resources 924 may include applications and/or data that can be utilized while computer processing is executed on servers that are remote from the computing device 902. Resources 924 can also include services provided over the Internet and/or through a subscriber network, such as a cellular or Wi-Fi network.

The platform 922 may abstract resources and functions to connect the computing device 902 with other computing devices 914 or 916. The platform 922 may also serve to abstract the scaling of resources to provide a corresponding level of scale to encountered demand for the resources 924 that are implemented via platform 922. Accordingly, in an interconnected device implementation, the implementation functionality described herein may be distributed throughout system 900. For example, the functionality may be implemented in part on the computing device 902 as well as via the platform 922 that abstracts the functionality of the cloud 920.

While this disclosure may contain many specifics, these should not be construed as limitations on the scope of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Under certain circumstances, multitasking and parallel processing may be utilized. Moreover, the separation of various system components in the implementations described above should not be understood as requiring such separation in all implementations, and it should be understood that the described program components and systems may generally be integrated together into a single software or hardware product or packaged into multiple software or hardware products.

Some systems may use certain open-source frameworks for storing and analyzing big data in a distributed computing environment. Some systems may use cloud computing, which may enable ubiquitous, convenient, on-demand network access to a shared pool of configurable computing resources (e.g., networks, servers, storage, applications, and services) that may be rapidly provisioned and released with minimal management effort or service provider interaction.

It should be understood that as used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Finally, as used in the description herein and throughout the claims that follow, the meanings of “and” and “or” include both the conjunctive and disjunctive and may be used interchangeably unless the context expressly dictates otherwise; the phrase “exclusive or” may be used to indicate situations where only the disjunctive meaning may apply.

What is claimed is:

1. A computer-implemented method of deploying a machine learning model, comprising:
receiving a user request for deploying a machine learning model, for an application, to an edge device;
determining a device constraint type associated with the edge device, wherein the device constraint type is one of a number of device constraint types associated with a plurality of edge devices capable of running the application;
identifying a machine learning model corresponding to the device constraint type of the edge device, wherein the machine learning model is one of a number of tiers of machine learning models developed for the application according to the device constraint types; and
deploying the machine learning model to the edge device.

2. The computer-implemented method of claim 1, wherein the machine learning models are developed and trained on a cloud device.

3. The computer-implemented method of claim 1, wherein the machine learning model is trained on the edge device after deploying to the edge device.

4. The computer-implemented method of claim 3, wherein, prior to determining the device constraint type associated with the edge device, the method further comprises:
receiving, from the edge device, device information for the edge device; and
determining the device constraint type associated with the edge device based on the received device information for the edge device.

5. The computer-implemented method of claim 1, wherein the device constraint types and the tiers of machine learning models have a one-to-one correspondence.

6. The computer-implemented method of claim 1, wherein the edge device is an enterprise server.

7. The computer-implemented method of claim 1, wherein a quantity of the device constraint types is determined based on device information of the plurality of edge devices capable of running the application.

8. The computer-implemented method of claim 1, wherein the machine learning models are trained based on user data reflecting one or more of user interests or user preferences of a user.

9. The computer-implemented method of claim 8, wherein an output of the trained machine learning models is tuned towards one or more of the user interests or user preferences of the user.

10. The computer-implemented method of claim 3, wherein the trained machine learning models generate invalid predictions if accessed by other users without exact user information of the user.

11. A system for deploying a machine learning model, comprising:
a processor; and
a memory, coupled to the processor, configured to store executable instructions that, when executed by the processor, cause the processor to perform operations including:
receiving a user request for deploying a machine learning model, for an application, to an edge device;
determining a device constraint type associated with the edge device, wherein the device constraint type is one of a number of device constraint types associated with a plurality of edge devices capable of running the application;
identifying a machine learning model corresponding to the device constraint type of the edge device, wherein the machine learning model is one of a number of tiers of machine learning models developed for the application according to the device constraint types; and
deploying the machine learning model to the edge device.

12. The system of claim 11, wherein the machine learning models are developed and trained on a cloud device.

13. The system of claim 11, wherein the machine learning model is trained on the edge device after deploying to the edge device.

14. The system of claim 13, wherein, prior to determining the device constraint type associated with the edge device, the method further comprises:
receiving, from the edge device, device information for the edge device; and
determining the device constraint type associated with the edge device based on the received device information for the edge device.

15. The system of claim 11, wherein the device constraint types and the tiers of machine learning models have a one-to-one correspondence.

16. The system of claim 15, wherein a quantity of the device constraint types is determined based on device information of the plurality of edge devices capable of running the application.

17. The computer-implemented method of claim 11, wherein the machine learning models are trained based on user data reflecting one or more of user interests or user preferences of a user.

18. A machine learning system, comprising:
a cloud training pipeline,
a deployment engine; and
an edge inference pipeline, wherein
the cloud training pipeline is configured to train a number of tiers of machine learning models for an application, a quantity of the number of tiers of machine learning models corresponding to a quantity of device constraint types for a plurality of edge devices capable of running the application;
the deployment engine is configured to deploy one of the number of tiers of machine learning models to an edge device based on a device constraint type of the edge device; and
the edge inference pipeline is configured to access a machine learning model deployed to the edge device to process received input to generate a prediction.

19. The machine learning system of claim 18, wherein the quantity of device constraint types is determined based on device information of the plurality of edge devices capable of running the application.

20. The machine learning system of claim 18, wherein the machine learning models are trained based on user data associated with a user, the user data reflecting one or more of user interests or user preferences of the user.
